(19) United States
(12) Patent Application Publication
(10) Pub. No.: US 2010/0289908 A1
(43) Pub. Date: Nov. 18, 2010

(54) CAMERA MODULE HAVING ANTI-SHAKE MECHANISM

(75) Inventor: CHAU-YUAN KE, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/582,817

(22) Filed: Oct. 21, 2009

(30) Foreign Application Priority Data
May 18, 2009 (CN) 200910302411.5

(51) Int. Cl. H04N 5/228

(52) U.S. Cl. 348/208.6; 348/E05.031

(57) ABSTRACT

An exemplary camera module includes a circuit board, an image sensor mounted on the circuit board, a lens module including a lens, a position sensor, a number of magnetic field generators mounted on the lens, and electrical wire groups arranged adjacent to the respective magnetic field generators. The lens is held a distance from the circuit board by holding wires fixed on the circuit board. The position sensor detects displacements of the lens module and the image sensor relative to the object. The electrical wire groups are subject to Ampere's forces and applying the reverse forces of the Ampere's forces to the magnetic field generators, such that the magnetic field generators together with the lens are moved to provide a correction of the displacements of the lens, thus an image of an object is captured at a predetermined region of the image sensor.

### CROSS-REFERENCE TO RELATED APPLICATION

This application is related to a commonly-assigned co-pending application entitled “CAMERA MODULE WITH ANTI-SHAKE MECHANISM” (Atty. Docket No. US25109). The above-identified application is filed simultaneously with the present application. The disclosure of the above-identified application is incorporated herein by reference.

### BACKGROUND

1. Technical Field

The present disclosure relates to camera modules, and particularly, to an anti-shake camera module.

2. Description of Related Art

Lens modules and image sensors are key components of camera modules. In normal use of a camera module, light rays conveying an image of an object transmit through the lens module along a predetermined path and fall on a central region of the image sensor. That is, an image plane of the object is precisely on the image sensor, and thus a clear image is obtained. However, inadvertent shaking of the camera module may occur during the time that an image is captured. When this happens, either or both of the lens module and the image sensor may move slightly relative to the object. In such case, the light rays from the object may not accurately fall on the image sensor. That is, the image plane of the object may not be precisely on the image sensor, resulting in a blurry image.

Anti-shake mechanisms that use motors have been devised to overcome these problems. In a typical anti-shake mechanism, a motor moves the image sensor to the image plane of the object. However, in general, motors are bulky and consume a great deal of electrical energy. In particular, the image sensor may have to be driven again and again each image capturing is performed.

What is needed, therefore, is a camera module which can avoid or overcome the above-described shortcomings.

### BRIEF DESCRIPTION OF THE DRAWINGS

Many aspects of the present camera module can be better understood with reference to the following drawings. The components in the drawings are not necessarily drawn to scale, the emphasis instead being placed upon clearly illustrating the principles of the present camera module. Moreover, in the drawings, like reference numerals designate corresponding parts throughout the several views.

FIG. 1 is an isometric view of a camera module in accordance with a first embodiment.

FIG. 2 is a side plan view showing a light path in a normal state of a lens and an image sensor of the camera module of FIG. 1 relative to an object.

FIG. 3 is a top plan view showing displacement of the lens and the image sensor shown in FIG. 2 relative to the object due to shaking of the camera module.

FIG. 4 is a side plan view corresponding to FIG. 3, showing the light path of FIG. 2 deviated by the displacement of the lens and the image sensor.

FIG. 5 is similar to FIG. 3, but showing correction of the displacement of the lens.

FIG. 6 is a side plan view corresponding to FIG. 5, showing correction of the deviated light path of FIG. 4.

FIG. 7 is an isometric view of a camera module in accordance with a second embodiment.

### DETAILED DESCRIPTION OF EMBODIMENTS

Embodiments of the present camera module will now be described in detail below and with reference to the drawings.

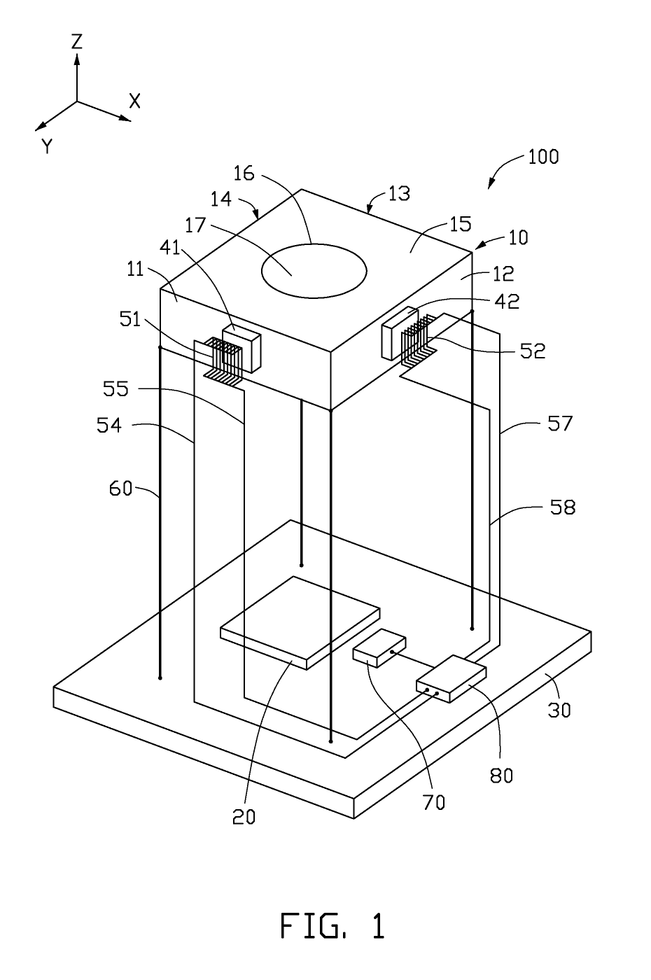

Referring to FIG. 1, an exemplary camera module 100 in accordance with a first embodiment is shown. The camera module 100 mainly includes a lens module 10, an image sensor 20, a circuit board 30, a position sensor 70, a controller 80, a first magnetic field generator 41, a second magnetic field generator 42, a first electrical wire group 51, and a second electrical wire group 52.

The lens module 10 includes a lens-holder 15 having a through hole 16, and a lens 17 received in the through hole 16. In the present embodiment, the lens-holder 15 is substantially rectangular, and the through hole 16 is round. The lens-holder 15 has four sidewalls 11, 12, 13 and 14. The sidewall 11 is adjacent and perpendicular to the sidewall 12. The lens module 10 is positioned above the circuit board 30 by four holding wires 60 which are fixed to the circuit board 30. When the camera module 100 is in a state in which no anti-shake function is performed, the holding wires 60 are parallel to each other, and parallel to an optical axis of the lens module 10. The optical axis is parallel to a Z axis of a Cartesian coordinate system, as illustrated. The holding wires 60 are stiff, but have some resiliency. The holding wires 60 can for example be made of metal. The flexibility of the holding wires 60 allows movement of the lens module 10 along an XY plane, which is perpendicular to the Z axis.

The first magnetic field generator 41 is fixedly mounted to the sidewall 11, and the second magnetic field generator 42 is fixedly mounted to the sidewall 12. The first electrical wire group 51 is arranged adjacent to the first magnetic field generator 41, and the second electrical wire group 52 is arranged adjacent to the second magnetic field generator 42. In the present embodiment, the first and second electrical wire groups 51, 52 each include a number of straight electrical wires which are parallel to each other.

Two ends of each of the straight electrical wires of the first electrical wire group 51 are connected to two electrical wires 54, 55 which extend down to the circuit board 30 and are electrically connected to the controller 80. The straight electrical wires of the first electrical wire group 51 and the electrical wires 54, 55 are made of rigid metal. Bottom portions of the electrical wires 54, 55 are fixed on the circuit board 30. In the illustrated embodiment, main portions of the electrical wires 54, 55 are straight and substantially parallel to an optical axis of the camera module 100 (which coincides with the optical axis of the lens module 10 when the camera module 100 is in a passive state). Thus the combination of the first electrical wire group 51 and the two electrical wires 54, 55 can be a discrete, freestanding part of the camera module 100. Two ends of each of the straight electrical wires of the second electrical wire group 52 are connected to two electrical wires 57, 58 which extend down to the circuit board 30 and are electrically connected to the controller 80. The combination of the second electrical wire group 52 and the two electrical wires 57, 58 has a structure and arrangement similar to those of the combination of the first electrical wire group 51 and its two electrical wires 54, 55. Gaps (not labeled) are maintained between the first and second magnetic field generators 41, 42 and the respective first and second electrical wire groups 51, 52, for allowing the lens module 10 to be moved along the XY plane.

In further or alternative embodiments, the combination of the first electrical wire group 51 and its two electrical wires 54, 55 can be mechanically supported by another component (not shown) of the camera module 100 or of an electronic device in which the camera module 100 is installed. The combination of the second electrical wire group 52 and its two electrical wires 57, 58 can be similarly mechanically supported.

Each of the first and second magnetic field generators 41, 42 is configured for generating a magnetic field around the respective first or second electrical wire group 51, 52. In the present embodiment, the magnetic field generated by each of the first and second magnetic field generators 41, 42 is a fixed magnetic field. Preferably, the direction of the magnetic field generated by each of the first and second magnetic field generators 41, 42 is perpendicular to the plane in which the respective first or second electrical wire group 51, 52 is oriented. In an alternative embodiment, the direction of the magnetic field generated by each of the first and second magnetic field generators 41, 42 can be parallel to the plane in which the respective first or second electrical wire group 51, 52 is oriented. Each of the first and second magnetic field generators 41, 42 can be a permanent magnet, or an electromagnet.

The image sensor 20, the position sensor 70, and the controller 80 are mounted on the circuit board 30. The position sensor 70 is capable of detecting motions of the lens module 10 and the image sensor 20. The controller 80 is electrically connected to the position sensor 70 and the first and second electrical wire groups 51, 52. The controller 80 is configured for applying current to the first and second electrical wire groups 51, 52 and controlling the magnitude, direction, and duration of the current based on the motions of the lens module 10 and the image sensor 20.

When shaking of the entire camera module 100 occurs, the shaking may for example lead to motions of the entire camera module 100 in directions along the X, Y and Z axes. In general, motion along the Z axis does not impact image quality, because the distance between the lens module 10 and the image sensor 20 is fixed. As such, only corrections to motions occurring along the X and Y axes are needed.

According to the Left Hand Principle, when current is applied to the first and second electrical wire groups 51, 52, due to the magnetic field generated by the first magnetic field generator 41, the first electrical wire group 51 is subject to Ampere's forces along two axial directions of the X axis, and due to the magnetic field generated by the second magnetic field generator 42, the second electrical wire group 52 is subject to Ampere's forces along two axial directions of the Y axis, depending on the direction of the current in each of the first and second electrical wire groups 51, 52. That is, the Ampere's forces may operate in positive or negative X directions, and in positive or negative Y directions. The first magnetic field generator 41 is subject to forces applied by the first electrical wire group 51, i.e., subject to reverse forces of the Ampere's forces from the first electrical wire group 51. The second magnetic field generator 42 is subject to forces applied by the second electrical wire group 52, i.e., subject to reverse forces of the Ampere's forces from the second electrical wire group 52. Because the first and second electrical wire groups 51, 52 are fixed in position and are rigid, the first and second electrical wire groups 51, 52 do not move. As such, the first and second magnetic field generators 41, 42 are moved in directions that are the reverse of the directions of the Ampere's forces, and drive the lens module 10 correspondingly.

Thus with the first and second electrical wire groups 51, 52 being fixed, the first and second magnetic field generators 41, 42 are capable of being selectively moved along the four axial directions in the XY plane, and the first and second magnetic field generators 41, 42 accordingly move the lens module 10 along selected of the four axial directions in the XY plane. When the current is switched off, the lens module 10 can return to an original position due to the resilient flexibility of the holding wires 60.

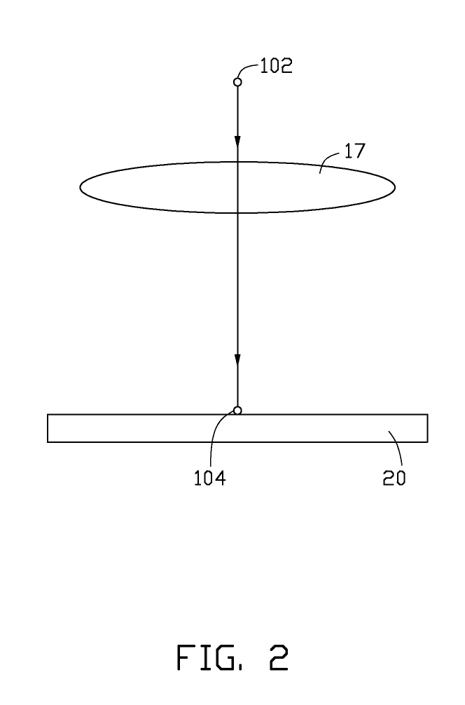

Referring to FIG. 2, in a normal image capturing state, an exemplary light ray transmits from an object 102 through the lens 17 onto a central region of the image sensor 20, and forms an image 104 on the image sensor 20. In this state, the controller 80 does not need to apply current to the first or second electrical wire groups 51, 52.

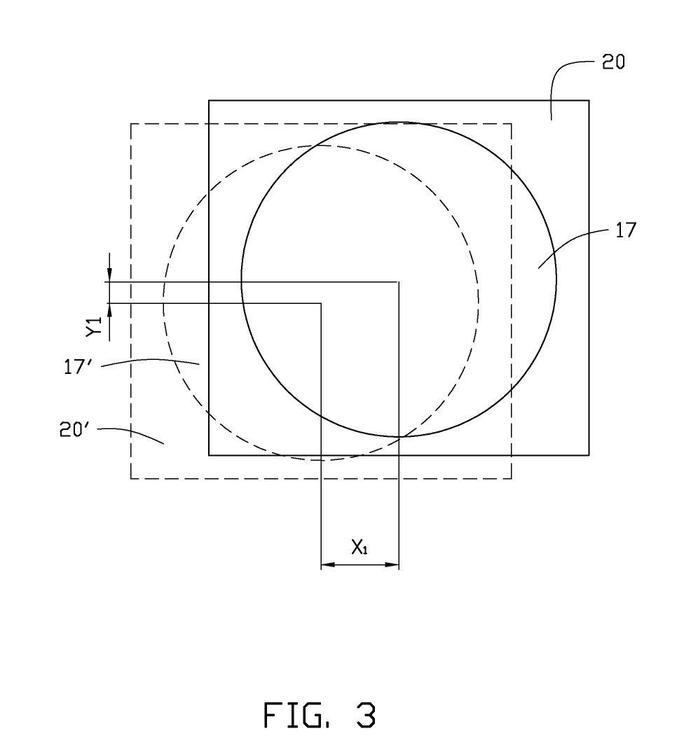

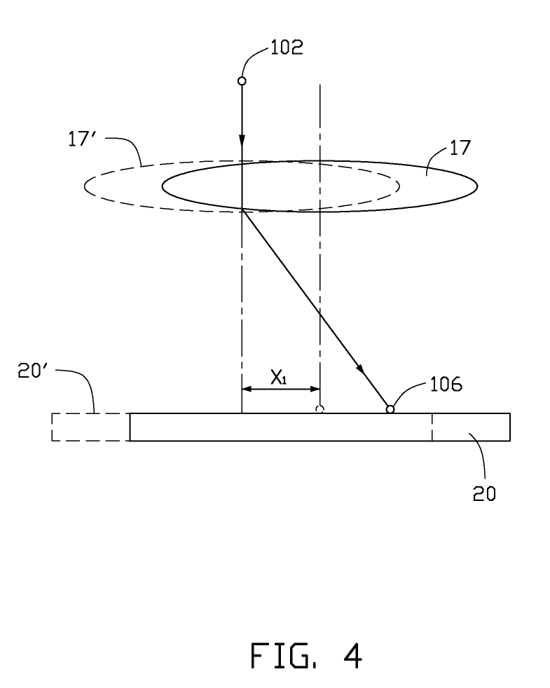

Referring to FIGS. 3 and 4, in this example, shaking of the camera module 100 occurs, and the lens 17 and the image sensor 20 are displaced from their respective original positions 17′, 20′. For example, each of the lens 17 and the image sensor 20 is displaced a distance X1 along the positive direction of the X axis, and a distance Y1 along the negative direction of the Y axis. In this state, if no correction were made to the displacement of the lens 17 or the displacement of the image sensor 20, the exemplary light ray from the object 102 would fall on a region of the image sensor 20 different from the central region, and form a blurry image 106 on the image sensor 20.

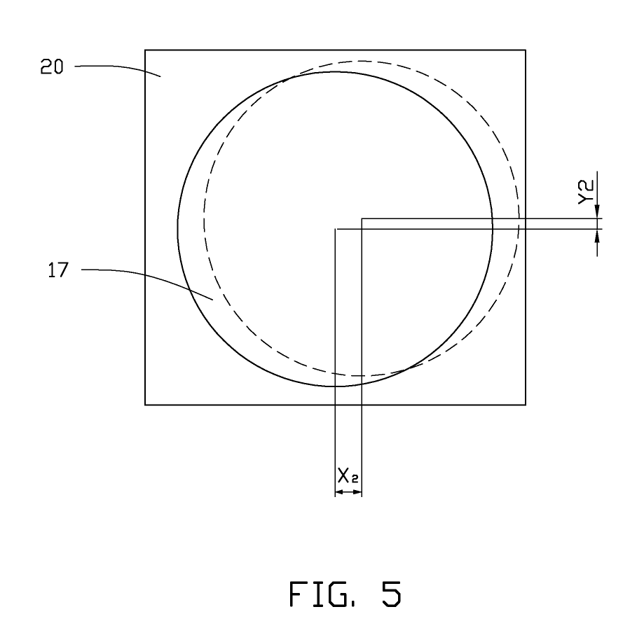

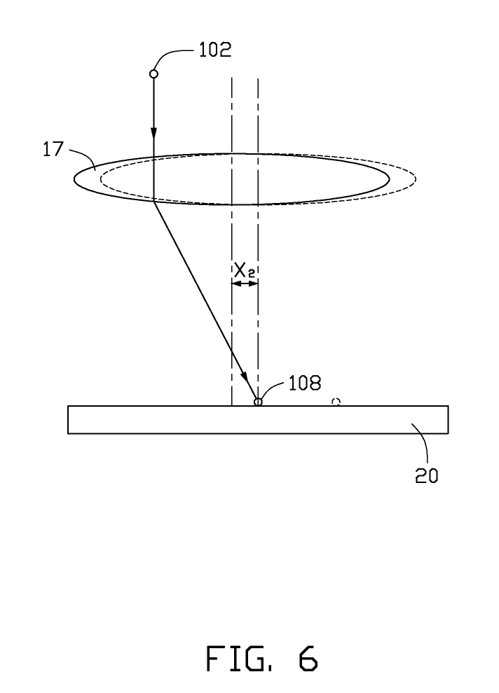

Referring to FIGS. 5 and 6, in this example, corrections to the displacement of the lens 17 are made. The lens 17 is moved back a distance X2 along the negative direction of the X axis, and back a distance Y2 along the positive direction of the Y axis. Thus, the optical light path of the exemplary light ray from the object 102 is compensated. In this way, the exemplary light ray from the object 102 falls on the central region of the image sensor 20, and forms an image 108. The position of the image 108 is similar to or substantially the same as the position of the image 104. Thus the exemplary light ray of the object 102 can still be correctly and clearly projected onto the central region of the image sensor 20 in spite of the shaking. In this way, the anti-shake function is achieved.

In other embodiments, other lens modules may be added to the camera module 100. If the other lens modules are movable along the illustrated Z axis relative to the image sensor 20, the entire camera module 100 can have a zoom function.

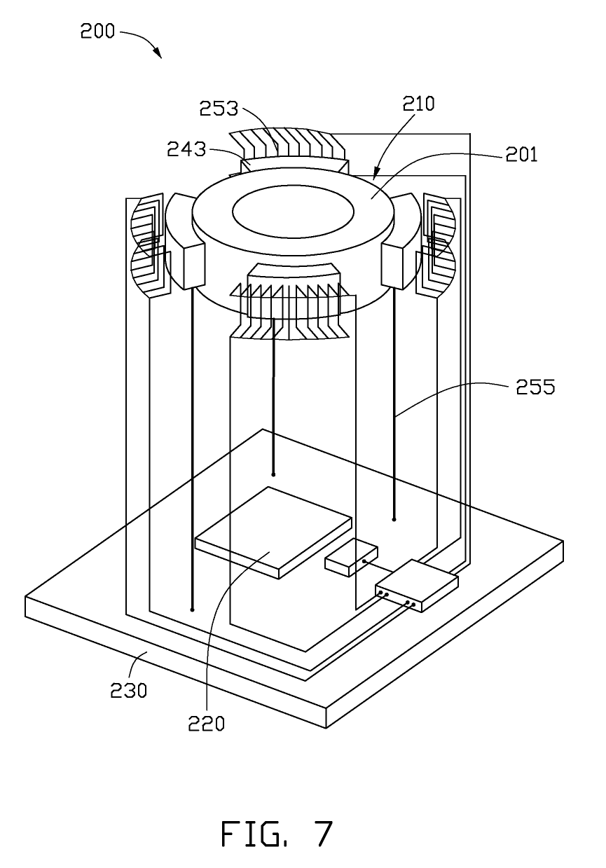

Referring to FIG. 7, an exemplary camera module 200 in accordance with a second embodiment is shown. The camera module 200 is essentially similar to the camera module 100 described above. However, a lens module 210 has a cylindrical (or annular) lens-holder 201, and four generally arc-shaped magnetic field generators 243 are equally angularly spaced from each other on the outside of the lens-holder 201. The lens-holder 201 is supported by three holding wires 255. Two of the magnetic field generators 243 are arranged symmetrically opposite each other across a center of the lens-holder 201, and the other two magnetic field generators 243 are arranged symmetrically opposite each other across a center of the lens-holder 201. Four electrical wire groups 253 are equally angularly spaced from each other around the outside of the lens-holder 201, with each electrical wire group 253 facing and adjacent to a respective magnetic field generator 243. In one alternative embodiment, there may be only two magnetic field generators 243, which are arranged essentially perpendicular to each other. That is, the two magnetic field generators 243 are angularly spaced from each other by an angle of 90°.

It is understood that the above-described embodiments are intended to illustrate rather than limit the disclosure. Variations may be made to the embodiments without departing from the spirit of the disclosure. Accordingly, it is appropriate that the appended claims be construed broadly and in a manner consistent with the scope of the disclosure.

What is claimed is:

1. A camera module for capturing an image of an object, the camera module comprising:
a circuit board;
an image sensor mounted on the circuit board;
a lens module comprising a lens, the lens module held a distance from the circuit board by a plurality of holding wires fixed on the circuit board;
a position sensor mounted on the circuit board and configured for detecting displacement of the lens module and the image sensor relative to the object;
a plurality of magnetic field generators mounted on the lens module, each magnetic field generator configured for generating a magnetic field; and
a plurality of electrical wire groups arranged adjacent to the magnetic field generators, respectively, each of the electrical wire groups being electrifiable in response to detection by the position sensor of displacement of at least one of the lens module and the image sensor relative to the object, such that at least one of the electrical wire groups and the corresponding magnetic field generator cooperatively drive the lens module to move to provide a correction of the displacement of at least one of the lens module and the image sensor relative to the object, such that the image of the object is captured at a predetermined region of the image sensor.

2. The camera module as described in claim 1, wherein the plurality of electrical wire groups comprises a first electrical wire group and a second electrical wire group, and the plurality of magnetic field generators comprises a first magnetic field generator for generating a first magnetic field and a second magnetic field generator for generating a second magnetic field, and upon electrification of the first electrical wire group, the first electrical wire group is subject to Ampere's forces in either of two opposite first component directions, and upon electrification of the second electrical wire group, the second electrical wire group is subject to Ampere's forces in either of two opposite second component directions, the first component directions and the second component directions being oriented in a plane perpendicular to an optical axis of the lens module, and the first component directions being perpendicular to the second component directions.

3. The camera module as described in claim 1, wherein each of the holding wires is stiff but resilient, and each of the holding wires is parallel to an optical axis direction of the lens module when none of the electrical wire groups is electrified.

4. The camera module as described in claim 1, further comprising a controller electrically connected to the position sensor and the electrical wire groups, the controller being configured for adjusting at least one of the magnitude, direction and period of time of current applied to any of the electrical wire groups based on the detection by the position sensor of displacement of at least one of the lens module and the image sensor relative to the object.

5. The camera module as described in claim 1, wherein each of the electrical wire groups comprises a plurality of straight electrical wires parallel to each other.

6. The camera module as described in claim 5, wherein two ends of each of the electrical wire groups are connected to two rigid metallic electrical wires, which extend to the circuit board and are fixed on the circuit board.

7. The camera module as described in claim 1, wherein the lens module further comprises a hollow lens-holder receiving the lens therein, and the holding wires and the magnetic field generators are mounted on the lens-holder.

8. The camera module as described in claim 7, wherein the lens-holder is rectangular and has four sides, and the plurality of magnetic field generators comprise two magnetic field generators mounted to adjacent sides of the lens-holder.

9. The camera module as described in claim 7, wherein the lens-holder is cylindrical, the plurality of magnetic field generators comprise two magnetic field generators mounted to a periphery of the lens-holder, and the two magnetic field generators are arranged essentially perpendicular to each other.

10. A camera module for capturing an image of an object, the camera module comprising:
a circuit board;
an image sensor mounted on the circuit board;
a lens module spaced from the circuit board by a plurality of stiff holding wires fixed on the circuit board;
a position sensor mounted on the circuit board and configured for detecting displacement of the lens module and the image sensor relative to the object;
a first magnetic field generator and a second magnetic field generator mounted on the lens module, each magnetic field generator configured for generating a magnetic field;
a first electrical wire group and a second electrical wire group arranged adjacent to the respective first and second magnetic field generators; and
a controller connected to the position sensor and the first and the second electrical wire groups, the controller being configured for applying current to at least one of the first and second electrical wire groups based on detection by the position sensor of displacement of at least one of the lens module and the image sensor;
wherein upon the application of current to the first electrical wire group, the first electrical wire group is subject to a first Ampere's force in either of two opposite first component directions and applies a first reverse force of the first Ampere's force to the first magnetic field generator, and upon the application of current to the second electrical wire group, the second electrical wire group is subject to a second Ampere's force in either of two opposite second component directions and applies a second reverse force of the second Ampere's force to the second magnetic field generator, such that at least one of the first and second magnetic field generators drives the lens module to move along at least one of the corresponding first and second component directions, thereby effecting a correction of the position of the lens module such that the image of the object is captured at a desired position of the image sensor.

11. The camera module as described in claim 10, wherein the first component directions and the second component directions are oriented in a plane perpendicular to an optical axis of the lens module, and the first component directions are perpendicular to the second component directions.

12. The camera module as described in claim 10, wherein each of the holding wires is stiff but resilient, and each of the holding wires is parallel to an optical axis direction of the lens module when none of the electrical wire groups is electrified.

13. The camera module as described in claim 10, wherein each of the first and second electrical wire groups comprises a plurality of straight electrical wires parallel to each other.

14. The camera module as described in claim 13, wherein two ends of each of the straight electrical wires are connected to two rigid metallic electrical wires which extend to the circuit board and are fixed on the circuit board.
